(19) United States
(12) Patent Application Publication
(10) Pub. No.: US 2024/0046187 A1
(43) Pub. Date: Feb. 8, 2024

(54) INTERVENTION AND FIELD CHARACTERISTIC MACHINE-LEARNED MODELING

(71) Applicant: INDIGO AG, INC., Boston, MA (US)

(72) Inventors: Ying XU, Brookline, MA (US); Max E. WINSTON, Boston, MA (US); Ching-Hao WANG, Boston, MA (US); Huan WANG, Belmont, MA (US); Sharon XU, Somerville, MA (US)

(21) Appl. No.: 18/268,564

(22) PCT Filed: Dec. 17, 2021
(86) PCT No.: PCT/US2021/064200

§ 371 Date: Jun. 20, 2023

Related U.S. Application Data
(60) Provisional application No. 63/130,307, filed on Dec. 23, 2020.
(60) Provisional application No. 63/145,826, filed on Feb. 4, 2021.

(51) Int. Cl. G06Q 10/0637; G06Q 50/02

(52) U.S. Cl. CPC G06Q 10/06375; G06Q 50/02

(57) ABSTRACT

One or more fields can be divided into portions, and different sets of interventions can be performed during the course of planting and growing a crop in each field portion. The effect of each set of interventions on the crop outcome of the corresponding field portion can be determined using a best performing model of a set of predictive models applied to the set of interventions. The selected model can be used to determine an effect of each intervention on crop outcome of a field portion by estimating a portion of the crop outcome attributable to the intervention. A machine-learned model can be trained based on the effect each intervention has on crop outcome determined by the selected model, and the machine-learned model can be applied to subsequent fields and crops to predict effects that various interventions can have on subsequent crop outcomes.

### CROSS-REFERENCE TO RELATED APPLICATIONS

This application claims the benefit of U.S. Provisional Applications No. 63/130,307, filed Dec. 23, 2020 and No. 63/145,826, filed Feb. 4, 2021, both of which are incorporated by reference in their entirety.

### TECHNICAL FIELD

This specification relates generally to an online agricultural system, and specifically to training a machine-learned model that estimates effects of interventions on the crop outcome of a field and detects possible interactions between the intervention and other environmental factors, which could provide insights on environment-specific intervention selection.

### BACKGROUND

Within a field used for farming, there can be subfield variations in different portions of the field due to features such as soil properties, topographical features, precipitation, and weather. Typically, controlled experiments are conducted on the field to determine how to improve crop yield. The controlled experiments may be conducted by dividing the field into portions, applying different types of interventions (e.g., pesticide, fertilizer, irrigation) to the different portions, and determining which portion resulted in the highest crop yield to identify the most effective intervention. However, a typical controlled experiment considers average crop yield of the portions of the field applied with different interventions without factoring in the effects of other productivity drivers such as field characteristics or environmental factors that may affect the crop yield. Therefore, the effectiveness of interventions selected based on the controlled experiments may be limited.

### SUMMARY

A farming management system trains a machine-learned model to determine an effect of farming interventions on a crop outcome produced by a portion of a target field based on a combination of subfield conditions input to the machine-learned model. The farming management system considers subfield conditions including environmental factors and field characteristics of field portions in analyzing the effects that one or more interventions would have on the field portions. The farming management system may use information from controlled experiments conducted on historical fields to generate training data for training the machine-learned model. For each historical field, the farming management system may apply a plurality of predictive models to known information about the field to estimate the intervention effects via predicting the crop outcome. Each predictive model can be evaluated by various statistical model performance metrics, including but not limited to AIC (Akaike information criterion) and BIC (Bayesian information criterion) scores. The predictive model that gets the best score to determine effects that the one or more interventions applied on the field had on crop outcome. The determined effects of the one or more interventions from all the historical fields are used as training data to provide insights or recommendations to end users.

Historical yield may be useful for predicting future yields, particularly when considering yield patterns across geographies. In addition to accounting for environmental conditions on the field, leveraging historical data on yield productivity can improve intervention effect estimates and account for more spatial variation across the field. The machine-learned modeling can be trained on data from a single field, referred to herein as “single-field models”, or from multiple fields as once, referred to herein as “multi-field models”. Both single-field and multi-field models can be applied to characteristics or conditions of a target field in order to estimate an effect that various interventions may have on crop productivity or other outcomes.

### BRIEF DESCRIPTION OF THE DRAWINGS

FIG. 1 is a block diagram of a system environment in which a farming management system operates, according to various embodiments.

FIG. 2 is a block diagram of an architecture of a farming management system, according to various embodiments.

FIG. 3A is a diagram illustrating the application of interventions on a field, according to various embodiments.

FIG. 3B is a diagram illustrating the crop yield in the field of FIG. 3A, according to various embodiments.

FIG. 4 illustrates an example process for generating effect prediction training data, according to various embodiments.

FIG. 5 illustrates an example process for predicting effects of interventions on a target field using a machine-learned model, according to various embodiments.

FIG. 6 is a flow chart illustrating a process for training a single-field machine-learned model for predicting effects of interventions on a target field, according to various embodiments.

FIG. 7A illustrates intervention effect prediction performance data for multiple variants of a single-field model relative to a naïve mean model simulated based on real-world historical field outcome data for winter wheat, according to various embodiments.

FIG. 7B illustrates intervention effect prediction performance data for multiple variants of a single-field model relative to a naïve mean model simulated based on real-world historical field outcome data for corn, according to various embodiments.

FIG. 8 is a flow chart illustrating a process for training a multi-field machine-learned model for predicting effects of interventions on a target field, according to various embodiments.

FIG. 9 illustrates intervention effect prediction performance data for multiple interventions using both single-field and multi-field prediction models simulated based on historical field outcome data, according to various embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

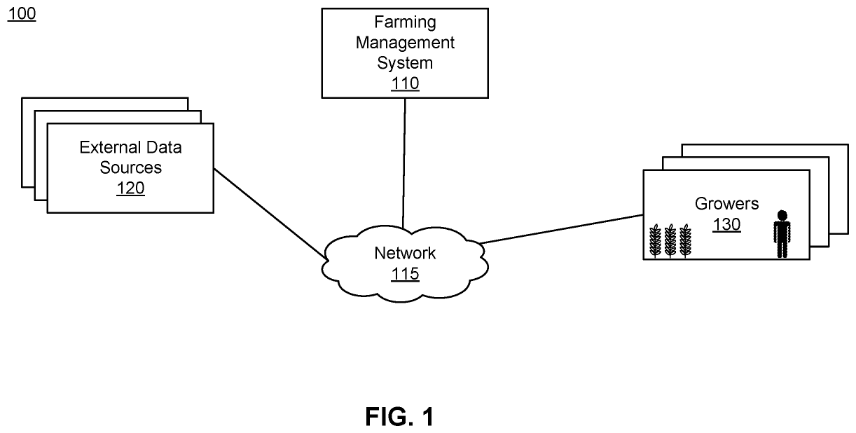

FIG. 1 is a block diagram of a system environment in which a farming management system operates, according to various embodiments. The system environment 100 shown in FIG. 1 includes a farming management system 110, one or more external data sources 120, and one or more growers 130 connected through a network 115. In alternative configurations, different and/or additional components may be included in the system environment 100.

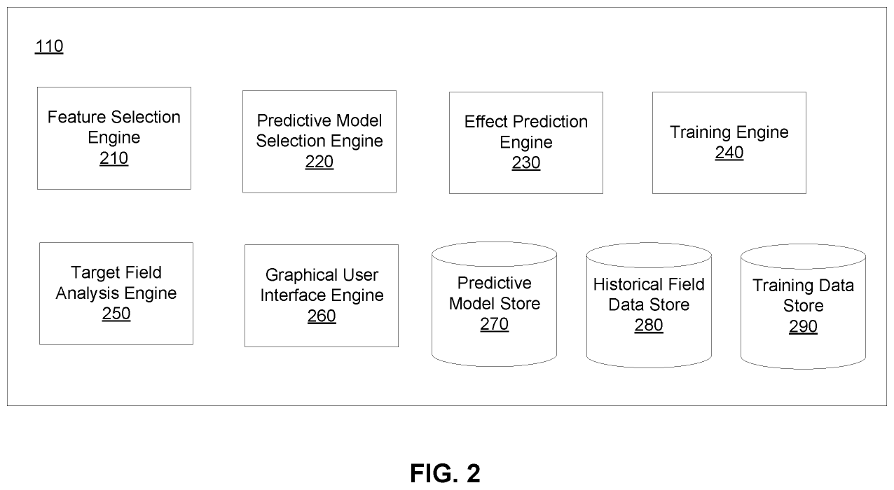

The farming management system 110 is an online agricultural system that manages farming data for growers 130. Each of the growers 130 may have a user account associated with the farming management system 110 and use the farming management system 110 to store farming data, receive farming data analysis, receive farming intervention recommendations, receive farming related information, communicate with other growers 130, and the like. The farming management system 110 may receive external data from the external data sources 120 and provide recommendations to the growers 130 for specific fields or field portions using machine-learned models configured to estimate the effect of interventions based on one or more of field characteristics, crop characteristics, historic and predicted future weather conditions, environmental conditions, and other factors that can affect crop yield. The term “interventions” as used herein refers to actions taken by the growers 130 (or by farming machines) to change farming conditions to improve or otherwise alter crop growth. That is, interventions are intended to alter farming conditions to create a better environment for a field portion given different field characteristics, crop characteristics, weather conditions, environment conditions, and other factors that can affect crop yield in the field portion. Interventions may include one or more of: applying products (e.g., pesticides, fungicides, fertilizers, nitrogen, biologicals, manure) to the field portion, varying seeding rate when planting in the field portion, varying types of crop planted in the field portion, varying types of tillage in the field portion, varying intensity of grazing in the field portion, varying types of cover crops planted in the field portion, varying planting date of the crop in the field portion, varying amount of water applied in the field portion, and the like. As used herein, a “cover crop action” can include a planting date of a cover crop, a type of cover crop, presence or absence of a cover crop, termination date of a cover crop, termination type of a cover crop (e.g. mowing, rolling or crimping, herbicide application, tillage, burning, winter kill, etc.), etc. The farming management system 110 is described in greater detail below with respect to FIG. 2.

It should be noted that although reference is made herein to crop “yield”, in practice, the models described herein can additionally or alternatively be trained on historical crop quality data, crop health data, soil carbon data (e.g., a quantification of soil organic carbon), greenhouse gas data (such as methane and nitrous oxide), or any other suitable crop outcome. Accordingly, the models described herein can be trained on and/or applied to data representative of any crop outcome or combination of outcomes, enabling users to identify characteristics or features responsible for observed crop outcomes, or to identify interventions that, if performed, can enable various crop outcomes.

It should also be noted that the models described herein can additionally or alternatively be purposed to assess and monitor crop condition and outcome during a crop growing season or in-season. Although reference is made herein to crop “yield”, a single-time measurement of a crop quality or quantity, in practice, the models described herein can repeatedly be trained on crop quality data, crop health data, soil carbon data, greenhouse gas data, or any other suitable crop outcome that are dynamic during a crop life cycle (such as leaf nitrogen content, vegetation indices derived from remote sensing instrument) to assess and monitor the crop growth and soil condition in-season.

As used herein, crop quality data or a crop “quality metric” may refer to any aspect of a crop or agricultural good that adds value. In some embodiments, quality is a physical or chemical attribute of the crop product. For example, a crop quality metric may include moisture content; protein content; carbohydrate content; ash content; fiber content; fiber quality; fat content; oil content; color; whiteness; weight; transparency; hardness; percent chalky grains; proportion of corneous endosperm; presence of foreign matter; number or percentage of broken kernels; number or percentage of kernels with stress cracks; falling number; farinograph; adsorption of water; milling degree; immature grains; kernel size distribution; average grain length; average grain breadth; kernel volume; density; LB ratio; wet gluten; sodium dodecyl sulfate sedimentation; toxin levels (for example, mycotoxin levels, including vomitoxin, fumonisin, ochratoxin, or aflatoxin levels); and damage levels (for example, mold, insect, heat, cold, frost, or other material damage).

As used herein, crop health data or a crop “health metric” can refer to any indicator of crop health, including but not limited to a measurement of crop growth (e.g. percent germination, stand count, etc.), tolerance or resistance to stress, disease or pest incidence, microbial profile (a presence, absence, or relative or absolute amount of a bacteria or fungi present in a soil or plant tissue), a vegetative index, and the like collected from any remote sensing instrument mounted on a platform. A vegetative index is computed from one or more spectral bands or channels of remote sensing data. Examples include simple ratio vegetation index (“RVI”), perpendicular vegetation index (“PVI”), soil adjusted vegetation index (“SAVI”), atmospherically resistant vegetation index (“ARVI”), soil adjusted atmospherically resistant VI (“SARVI”), difference vegetation index (“DVI”), and normalized difference vegetation index (“NDVI”) and normalized difference red-edge index (“NDRE”).

The growers 130 may interact with the farming management system 110 using one or more client devices. In some embodiments, growers 130 are crop producers, e.g., farmers actively engaged in and responsible for the production of agricultural crops. In other embodiments, the growers 130 may be agronomists, crop input producers, crop insurance providers, or any other people or entities that interact with the farming management system 110. The growers 130 may manage and track farming practices using services provided by the farming management system 110.

A client device is a computing device that can transmit and/or receive data via the network 115. A grower 130 may use the client device to perform functions such as submitting requests for intervention recommendations, providing information associated with the field, providing information associated with previous interventions performed and corresponding crop yields for one or more field portions, viewing intervention recommendation from the farming management system 110, communicating with other growers 130, and the like. For example, the client device may be a smartphone or tablet, notebook, or desktop computer, navigation device, or electronic logging device (ELD). In addition, the client device may be an Internet-of-Things (IOT) connected device such as a vehicle or farming equipment. The client device may include a display device on which the user may view digital content. It should be noted that reference made herein to the modification of a displayed interface (e.g., to display reports on interventions and suggested actions) may include embodiments wherein the steps described in conjunction with the modification of the displayed interface are performed internally by the farming management system 110.

The client device may execute one or more applications (“apps”) that extend the functionality of the client device. For example, the apps may include a web browser that allows the client device to interact with websites provided by servers connected to the network 115. The apps may also include one or more dedicated apps for accessing the farming management system 110 or external data sources 120. In some embodiments, the functionality of an app may be incorporated into an operating system of the client device or included in other native functionality of the client device.

External data sources 120 can access, produce, and/or store data describing current or historic information impacting crop yield. For example, data accessed by the farming management system 110 via the external data sources 120 may include remote sensing data (for example, satellite imagery, imagery collected from unmanned aerial vehicles (UAVs), imagery collected from manned aerial vehicles (MAVs)), weather data, precipitation data, soil composition data, topography data, intervention data, and the like. Example data sources 120 can include but are not limited to: weather databases, satellite imagery databases, map databases, and the like. As used herein, “image data” or “imagery” can refer to viewable image files (for instance, in the .JPG or .PNG format), to reflectance and absorbance data at one or more spectral bands including a continuous range of spectra (e.g. hyperspectral images), to light data in both the visible (e.g. light between about 375 nm and 725 nm in wavelength) and non-visible spectrum (e.g. light within the infrared “IR” or ultraviolet “UV” spectrums) and combinations of visible and non-visible spectrum, or to any representation of light signals. Remote sensing data include one or more measurements of land, water, or atmospheric properties using reflected or emitted electromagnetic radiation collected by satellites (e.g., sun synchronous/polar orbiting; non-polar orbiting; geostationary), UAVs, and MAVs. Remote sensing data includes passive and active measurements. Passive measurements include one or more of optical measurements (e.g., reflected solar radiation, multispectral, hyperspectral), thermal measurements (e.g., emitted longwave radiation), and microwave measurements. Active measurements include one or more of radar measurements (radio detection and ranging) and lidar measurements (light imaging, detection, and ranging). Remote sensing data may be used to determine a temperature of a surface, moisture and structure of a surface, a topography of a surface, elevation of a surface, three-dimensional structure of a surface, imagery data, and the like.

The network 115 comprises any combination of local area and/or wide area networks, using both wired and/or wireless communication systems. In one embodiment, the network 115 uses standard communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 115 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 115 may be represented using any suitable format, such as hypertext markup language (HTML) or extensible markup language (XML). In some embodiments, all or some of the communication links of the network 115 may be encrypted using any suitable technique or techniques.

### Farming Management System Architecture

FIG. 2 is a block diagram of an architecture of a farming management system, according to various embodiments. The farming management system 110 includes a feature selection engine 210, a predictive model selection engine 220, an effect prediction engine 230, a training engine 240, a target field analysis engine 250, a graphical user interface engine 260, a predictive model store 270, a historical field data store 280, and a training data store 290. In alternative configurations, different and/or additional components may be included in the farming management system 110.

The farming management system 110 may receive a request from a grower 130 for a custom intervention recommendation for a target field that indicates which set of interventions to apply to different portions of the grower's field to increase product yield in the field. Depending on characteristics of a portion of a field and on environmental factors, the types of interventions that are effective for increasing the crop yield for the field portion may vary. A portion of the field (also referred to as “field portion”) may be associated with one or more crop features that may affect crop yield including one or more of: an amount of fertilizer applied to a planted crop, an amount of a biological treatment applied to a planted crop, a type or amount of tillage, a type and amount of fungicide applied to a planted crop, a type of crop planted, a cover crop or type of cover crop, grazing or a grazing rotation, characteristics of the planted crop, a seeding rate of the crop planted, a planting date of the crop, and the like. The portion of the field may also be associated with one or more features corresponding to field characteristics and/or environment attributes, including one or more of: characteristics of soil (e.g., soil organic matter, soil texture, soil pH value, cation-exchange capacity), a moisture level of the soil, types of microbes in the soil, historic weather information, predicted weather information, one or more topographical characteristics (e.g., elevation, topographic position index (TPI), terrain ruggedness index (TRI), slope degree, aspect degree), historical productivity, and the like.

When the farming management system 110 receives the request from the grower 130 for the custom intervention placement recommendation for the target field, the farming management system 110 applies one or more machine-learned models (such as single-field models or multi-field models) via the target field analysis engine 250 to consider candidate inventions for portions of the target field and to determine the effects of the considered candidate interventions. The farming management system 110 can automatically select one or more target interventions to recommend for each portion of the target field based on determined effects of the one or more target interventions on crop yield of the target field portion. It should be noted that in some embodiments, the target field analysis engine 250 may be located outside of or within a different system than the farming management system 110, and that the target field analysis engine 250 may provide automated reports directly to the grower 130 (independent or in coordination with the farming management system 110).

In some embodiments, the requesting grower 130 may indicate the candidate interventions that they are considering to the farming management system 110 and may request a recommendation among the indicated candidate interventions. The target field analysis engine 250 may include a machine-learned model that is trained based on data associated with historical fields to predict effects of interventions on a target field, as described herein in greater detail. A historical field may be a field on which a controlled experiment was conducted by applying one or more selected interventions and observing a resulting crop yield. In other embodiments, a historical field may be a field on which applied interventions and crop yield were determined retroactively. Based on the information known about the historical fields, such as the interventions applied, field characteristics, environmental factors, and the resulting crop yield at the historical fields, the farming management system 110 gathers insights on the effects of different interventions performed for different types of fields, and trains machine-learned models (via the training engine 240, as described below) that can be applied (via the target field analysis engine 250) to predict effects that interventions will have on target fields without having to perform the interventions or conduct actual intervention experiments.

For each historical field, the farming management system 110 stores information representative of the historical field within the historical field data store 280. Stored information representative of the historical field can include but is not limited to information describing geographic characteristics of the historical field, geologic characteristics of the historical field, historical crops planted and crop yield, and environment and weather information corresponding to the historical field. For example, the characteristics of the historical field may include an annotated map indicating a field boundary of the historical field, soil sample data from the historical field, elevation features associated with the field, and the like.

The historical fields corresponding to the information stored within the historical field data store 280 can be located in geographically distinct and distributed locations, for instance within different counties, states, countries, or continents. Likewise, the historical fields can correspond to distinct and distributed climates, weather patterns, soil types, geologic characteristics, altitudes, humidity or moisture levels, shade levels, exposure to sun, temperatures, farming operations or methodologies, crop types planted, or any other characteristic associated with a field or crop.

The information stored within the historical field data store 280 may include, for a historical field, an annotated map indicating crop placement (e.g., a map showing portions of the historical field where different types of crops were planted), an annotated map showing crop yield as harvested in the historical field, an annotated map indicating intervention application (e.g., a map showing where different types of interventions were applied), data corresponding to geographic locations outside of the context of a map (e.g., the precise or approximate latitude and longitude or GPS coordinates and corresponding field or crop characteristics at the locations), and the like. In some embodiments, the farming management system 110 may determine interventions performed on a historical field portion based on satellite imagery of the field portion, and can store the determined interventions in conjunction with the historical field portion within the historical field data store 280. Likewise, the farming management system 110 can determine weather information corresponding to a historical field portion from a weather database and can store the weather information in conjunction with the historical field portion within the historical field data store 280.

Information representative of historical fields can be represented spatially, for instance by indicating a distribution of field characteristics, crop characteristics, intervention operations performed, environmental characteristics, weather characteristics, and the like over a field portion. For example, a first sub-portion of a field portion can be associated with a greater average historical sun exposure than a second sub-portion of the field portion, and the historical field information can include a spatial representation of the sun exposure for the field portion that differentiates between the average sun exposure between the first sub-portion and the second sub-portion of the field portion.

As described below, the farming management system 110 accesses historical field information from the historical field data store 280 corresponding to one or more field portions, and applies one or more predictive models to one or more features of the accessed historical field information (via the feature selection engine 210). The farming management system 110 then determines which of the predictive models performs the best in view of interventions performed on the one or more field portions (via the predictive engine selection engine 220). Using the best performing models, the farming management system 110 can determine the effects of interventions performed on the one or more field portions on the crop yields of those one or more field portions. The determined effects on the crop yield of the interventions performed on a field portion is stored as training data within the training data store 290 in conjunction with other field, crop, and environmental characteristics corresponding to the field portion. The training data can correspond to one historical field or multiple historical fields. In some embodiments, the training data can correspond to multiple historical fields, but a training set of data corresponding to one historical field can be generated from the training data.

### Single-Field Machine-Learned Models

Machine-learned predictive models can be trained based on data corresponding to a single historical field, and particularly to data representative of varying interventions performed on different portions of the historical field and corresponding crop outcomes for the portions of the historical field. It should be noted that, as described below, the principles described herein with regards to the training and application of a single-field model are equally applicable to the training and application of multi-field models (e.g., using training data corresponding to multiple geographically diverse and distributed field portions).

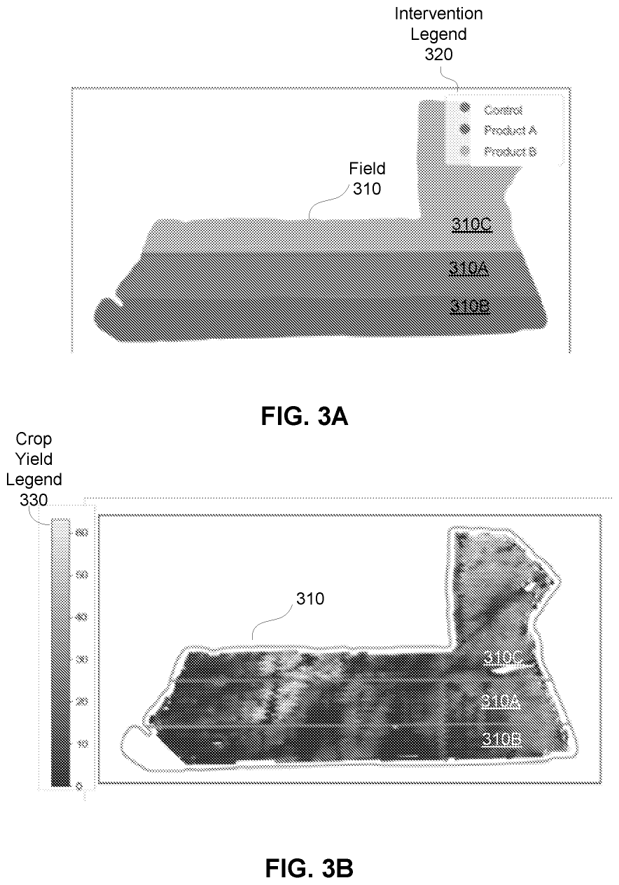

FIGS. 3A and 3B illustrate example data associated with a historical field. FIG. 3A is a diagram illustrating the application of interventions on a field, and FIG. 3B is a diagram illustrating the crop yield in the field of FIG. 3A, according to various embodiments. A controlled experiment may be performed on the field 310, which is divided into a first portion 310A, a second portion 310B, and a third portion 310C. The entire field 310 may be planted with a same type of crop, but different types of interventions may be performed on the different portions of the field 310 to determine how each of the different types of intervention affects the crop yield. For example, as shown in an intervention legend 320, the first portion 310A is used as a control, and no interventions are applied to the first portion 310A.

In contrast, a first intervention is performed on the second portion 310B (e.g., via the application of product A to the second portion 310B), and a second intervention is performed on the third portion 310C (e.g., via the application of product B). It should be noted that although different interventions are applied in each field portion of field 310 in the embodiment of FIG. 3A, in other embodiments, the same interventions can be performed on different field portions, but the effects the interventions have on each field portion can vary due to differences in characteristics of the field portions. It should also be noted that although the embodiment of FIG. 3A corresponds to a controlled experiment, in practice the farming management system 110 can retroactively determine interventions performed on field portions and the corresponding crop yields for the field portions without advance planning.

FIG. 3B illustrates the resulting crop yield at the field 310 where the color at a location on the field 310 indicates a measure of crop yield corresponding to the location. The crop yield legend 330 shows that the closer the color is to purple, the lower the crop yield, and the closer the color is to yellow, the higher the crop yield. Although the same type of intervention is performed within a given field portion, the crop yield is not consistent across the entire field portion. The discrepancy in the application layout of FIG. 3A and the crop yield layout of FIG. 3B is due to other factors that are affecting the crop yield. Accordingly, determining averages of the crop yield over the field portions and comparing the average values between field portions may not result in an accurate assessment of the effect that interventions have on crop yield. As noted herein, examples of such other factors that result in crop yield variance within a field portion include soil characteristic variance within the field portion, sunlight exposure variance within the field portion, elevational variance within the field portion, and the like. As described below, for each field portion of the field 310, the farming management system 110 selects a subset of features (interventions, soil characteristics, crop characteristics, and the like) of interest and selects a predictive model that predicts a crop yield closest to the actual crop yield illustrated in FIG. 3B based on the selected subset of features.

There are many potential features associated with a field portion for use in training a machine-learned model, and so it may be time consuming and expensive to consider all possible combinations of features that could affect crop yield. However, there is no ground truth data indicating which of the features are most useful for explaining crop yield variations in a field portion. Accordingly, in some embodiments, for one or more field portions of a historical field, the feature selection engine 210 may access corresponding entries in the historical field data store 280 and select a subset of the features that are of interest to the farming management system 110 and/or growers 130. For example, the selected subset of features can include interventions applied to field portions during a controlled experiment to determine the effects that interventions that were applied during the controlled experiment had on crop yield. The subset of features may also include interventions generally known to affect crop yield, such as the application of nitrogen to a field portion.

The predictive model selection engine 220 receives the selected subset of features associated with a field portion from the feature selection engine 210 and selects a predictive model that best predicts the crop yield of the field portion. A plurality of predictive models may be stored in the predictive model store 270, and may each be configured to predict a crop yield based on various or different combinations of features. The plurality of predictive models may include statistical models and/or machine-learned models. The statistical models may include a spatial regression model, which uses the inherent spatial correlation structure of fields to approximate the missing features. The machine-learned models may include one or more of a neural network, a decision tree, a polynomial regression model, a Bayesian network, and the like. The predictive model selection engine 220 identifies one or more candidate predictive models in the predictive model store 270 that are configured to operate on one or more features in the selected subset of features. In some embodiments, one or more of the plurality of predictive models have been trained in advance of determining crop yields of field portions. In some embodiments, one or more of the plurality of predictive models may be trained after or in response to accessing crop yield information and intervention information corresponding to field portions.

For each of the one or more candidate predictive models, the predictive model selection engine 220 may apply the candidate predictive model to known information about the field portion to determine a predicted crop yield generated by the candidate predictive model. After all of the candidate predictive models have generated a predicted crop yield for the field portion, the predictive model selection engine 220 compares the model performance according to certain performance metrics (such as overall yield prediction accuracy for the field portion, spatial similarity to yield prediction within the field portion, and/or predicted yield variance within the field portion). Based on the comparison, the predictive model selection engine 220 selects the best performing candidate predictive model for use in creating a training data set for use in training a machine-learned model. There are many possible methods for selecting a most predictive model from the one or more candidate predictive models, but one example is described below in detail.

In some embodiments, the spatial regression models with different formulations are used as the candidate predictive models. The spatial regression model utilizes the spatial location information to approximate all the unknown outcome influencers, and under certain circumstances the model is able to decouple the intervention effect and other spatial outcome confounders, so that one can obtain an accurate assessment of the intervention effect. In details, the model can be expressed as

Y(s)=X(s)β+ω(s) (Equation 1).

In Equation 1, X(s) is a matrix of n fixed features (x1, x2, . . . xn) being considered by the predictive models at the location s and β is the effect size vector (β1, β2, . . . βn) associated with the features. The term ω(s) in Equation 1 represents a spatial random process which accounts for the crop yield contribution from unidentified features that are not considered by the predictive model plus the random noise. Additional assumptions are often put on w(s), generally describing how the correlation decays when the distance increases.

In some embodiments, the predictive model selection engine 220 may select the most predictive model for a field portion in a two-stage process after receiving a subset of features of interest corresponding to the field portion from the feature selection engine 210. In the following example, the predictive model determines model performance based on crop yield, but in other embodiments, other crop outcomes may be used. In the first stage, the predictive model selection engine 220 selects a predictive model that best performs at predicting crop yield based on the subset of features. For example, if the subset of features includes a first feature F1 (e.g., an intervention product), a second feature F2 (e.g., the application of nitrogen), and a third feature F3 (e.g., the application of fungicide), the predictive model selection engine 220 considers a plurality of candidate predictive models that considers one or more of the features in the subset of features. One or more of the plurality of candidate predictive models may consider one or more of the features independently or additionally consider interactions between two features. For each of the plurality of candidate predictive models, the predictive model selection engine 220 applies information associated with the field portion that is applicable to the candidate predictive model. For example, for a candidate model that considers the first feature F1 and the third feature F3, the predictive model selection engine 220 may provide a map indicating intervention application and a map indicating fungicide application as inputs to the candidate model, and the candidate model may predict an output crop yield based on these two features.

When the plurality of candidate predictive models output predicted crop yields for a field portion, the predictive model selection engine 200 compares the model performance. In some embodiments, the predictive model selection engine 200 may use a performance metric such as Akaike Information Criterion (AIC) or Bayesian Information Criterion (BIC) to select the predictive model. In the second stage, the predictive model selection engine 220 may perform forward feature selection for the selected predictive model to consider additional features that were not considered in the first stage but may improve the crop yield prediction of the selected predictive model.

After the predictive model selection engine 220 selects a best performing predictive model for the field portion, the effect prediction engine 230 applies the selected predictive model to the data associated with the field portion to determines effects that the one or more interventions performed on the field portion had on the crop yield of the field portion. The effect prediction engine 230 may also use the selected predictive model to determine effects that one or more other features including field characteristics, crop characteristics, or environmental factors have on crop yield. For each of the one or more interventions applied, the effect prediction engine 230 may determine an effect that represents the contribution that the intervention had on crop yield. Similarly, for each of the one or more features, the effect prediction engine 230 may determine the contribution of the feature on crop yield. The effect prediction engine 230 may also determine a relative feature importance of a fixed feature by determining a variance of the fixed feature divided by a variance of the predicted crop yield Y(s). It may also determine a relative importance of the effect of the fixed features and spatial random effect with regards to the predicted crop yield.

The determined effects of the interventions and/or the other features are stored as part of a training data set in the training data store 290. In some embodiments, the effect prediction engine 230 may also determine a relative importance of the intervention and/or other features on crop yield. The training data set stored within the training data store 290 may include, for each of a plurality of historical field portions, information representative of the effect that one or more interventions and/or field characteristics has on crop yield for the historical field portions. In some embodiments, the training set of data is generated by the training engine 240, for instance in response to a request from a user, in response to a threshold number of best performing predictive models being selected in response to analyzing historical field, intervention, and crop yield data, or continually as additional predictive models are identified and applied to determine an effect each intervention, field characteristic, crop characteristic, environment condition, or combination thereof has on crop yield. The training set of data can include, for each of a plurality of historical fields or field portions, an effect that one or more interventions has on a crop yield for the historical field or field portion.

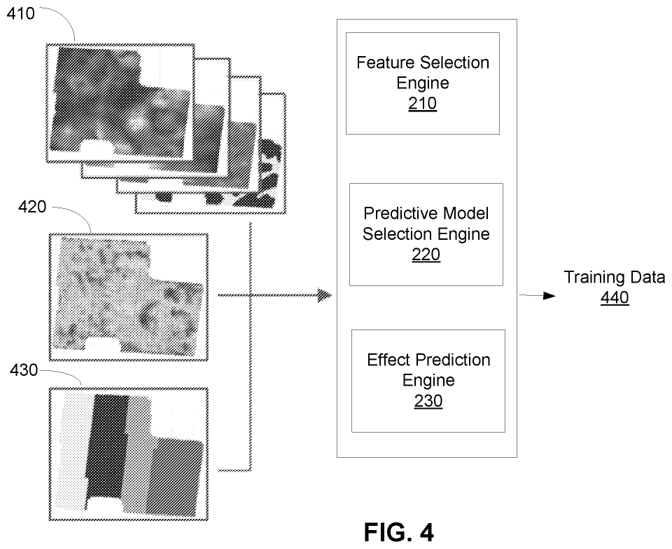

FIG. 4 illustrates an example process for generating effect prediction training data for the training of a single-field predictive model, according to various embodiments. Information known about a historical field (e.g., the environmental features 410, the crop yield data 420, and the intervention application map 430) is accessed, and the feature selection engine 210 selects one or more of the features. The predictive model selection engine 220 applies one or more predictive models to the selected features, and selects a best performing predictive model based on the predictive model that predicts a crop yield closest to the actual crop yield for the historical field. The effect prediction engine 430 then determines the effect that one or more interventions has on crop yield using the selected predictive model, and stores the effect that the interventions have as training data 440 within the training data store 290.

Referring back to FIG. 2, the training engine 240 trains a machine-learned model using the training data stored in the training data store 290 to predict an effect on crop yield as a result of one or more interventions, field characteristics, crop characteristics, and the like. For instance, the machine-learned model may be trained to receive an input including information about a target field and to predict effects of interventions on the target field, for instance without human input or involvement. The received input may include satellite imagery of the target field and/or location data such as coordinates, address, and the like that may be used to retrieve additional environmental information associated with the target field. The received input may also include information associated with a user account associated with the grower 130 of the target field and information provided by the grower 130 and/or external data sources 120. The trained machine-learned model may include one or more of a neural network, a decision tree, a polynomial regression model, a Bayesian network, and the like. In some embodiments, after the machine-learned model has been trained, the machine-learned model may be added to the predictive model store 270 to be used for generating training data for other machine-learned models.

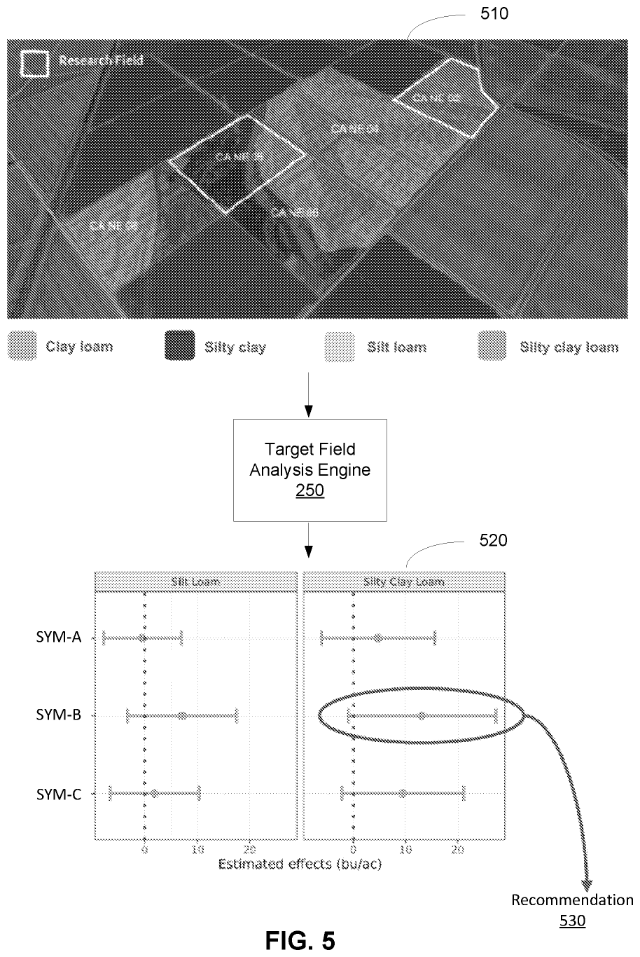

FIG. 5 illustrates an example process for predicting effects of interventions on a target field using a machine-learned model, according to various embodiments. The target field analysis engine 250 receives information about a target field 510. The target field 510 may be divided into a plurality of field portions (e.g., CA NE 02, CA NE 04, etc.) and the field portions may have different characteristics. For example, a first field portion CA NE 02 may have silt loam soil while a second field portion CA NE 05 has silty clay soil, and the different soil characteristics may cause an intervention to have different effects on the crop yield depending on the field portion that it is applied to. The target field analysis engine 250 applies the trained machine-learned model to predict effects that interventions (e.g., SYM-A, SYM-B, SYM-C) have on field portions based on the inputted information associated with the field portions. The predicted effects are illustrated in the estimated effect diagram 520, which shows that an intervention SYM-B had the greatest effect on product yield among the three intervention types in both silty clay loam and silt loam. Further, the estimated effect diagram 520 shows that the intervention SYM-B has a greater effect on crop yield in silty clay loam than silt loam.

Based on the predicted effects of the interventions determined by the target field analysis engine 250, the farming management system 110 may generate a recommendation 530 to the grower 130 associated with the target field 510 to apply the intervention SYM-B in the second field portion CA NE 05. The recommendation 530 may be presented in a graphical user interface generated by the graphical user interface engine 260. The graphical user interface engine 260 generates a graphical user interface for the growers 130 to interact with functions of the farming management system 110 and receive information from the farming management system 110.

In some embodiments, the graphical user interface engine 260 generates a first interface that can be presented to a grower 130, for instance in response to a request from the grower and prompting the grower 130 to enter one or more characteristics of a field, field portion, geographic coordinates or boundaries of the field or field portion, a planted crop, a soil condition, and the like. In response to receiving the information entered by the grower, the graphical user interface engine 260 can access a set of interventions that can improve or optimize crop yield by applying the machine-learned model described herein to the received information, and can generate a second interface to present the accessed set of interventions to the grower 130. In some embodiments, the graphical user interface engine 260 can generate a first interface that can be presented to a grower 130 that prompts the grower 130 to enter field characteristics, crop characteristics of a planted crop, and the like, and additionally prompts the grower to enter one or more interventions that the grower intends to perform on the planted crop. In response, the graphical user interface engine 260 can apply the machine-learned model to the one or more interventions and the additional information, and can generate a second interface to present information corresponding to the intended interventions that can improve crop yield based on an output of the machine-learned model (e.g., such as a date to perform an intervention, an amount of a treatment corresponding to an intervention to apply, a method of performing an intervention, and the like).

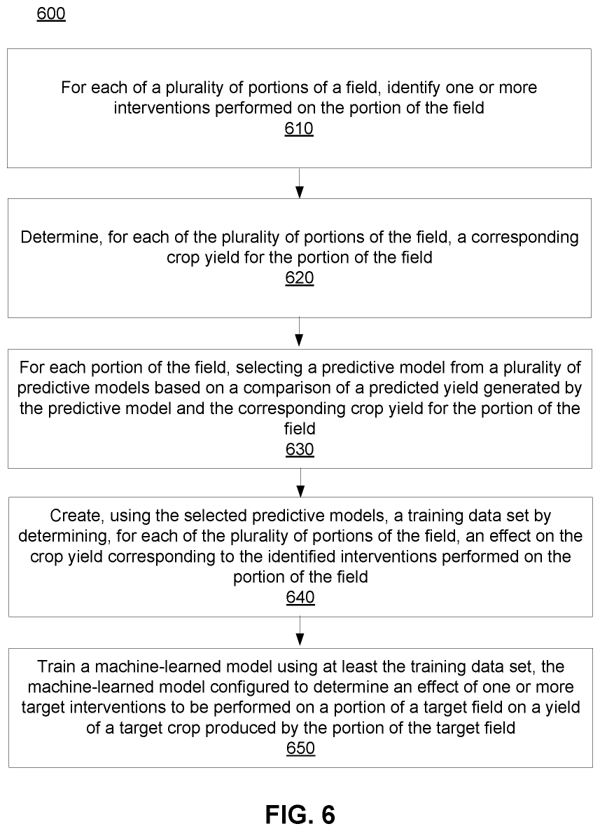

FIG. 6 is a flow chart illustrating a process 600 for training a machine-learned model for predicting effects of interventions on a target field, according to various embodiments. For each of a plurality of portions of a field of a plurality of historical fields, a farming management system identifies 610 one or more interventions performed on the portion of the field. In some embodiments, the farming management system identifies field characteristics, crop characteristics, and other factors that may affect crop outcome. The farming management system additionally determines 620 a corresponding crop outcome for the portion of the field.

The farming management system applies each of a plurality of predictive models to the identified interventions and determined crop outcome for the portion of the field, and selects 630 a best performing predictive model from a plurality of predictive models based on a model performance metric. The farming management system creates 640 a training data set by determining an effect on the crop outcome corresponding to the identified interventions performed on the portion of the field using the selected predictive model. The farming management system trains 650 a machine-learned model using at least the training data set, the machine-learned model configured to determine an effect of one or more target interventions to be performed on a portion of a target field on a crop outcome of a target crop produced by the portion of the target field.

In some embodiments, the farming management system can use the selected predictive models to determine which interventions, field characteristics, crop characteristics, or other factors are responsible for or attributable to particular measures of crop outcomes. For instance, a selected predictive model can determine that the application of a particular fertilizer is responsible for an increase in crop yield, or can determine that a planting date is 40% responsible for a particular measure of crop quality and a crop variant is 60% responsible for the particular measure of crop quality. In such embodiments, an interface displayed on a device (such as a device of a grower) can be modified to include the interventions, field characteristics, crop characteristics, and the like responsible for a particular crop outcome, and can be modified to include metrics of responsibility for the determined crop outcome (such as the “40%” and “60%” in the previous example). This beneficially enables, for instance, a crop grower to evaluate a success of interventions, field characteristics, crop characteristics, and the like in improving a crop outcome.

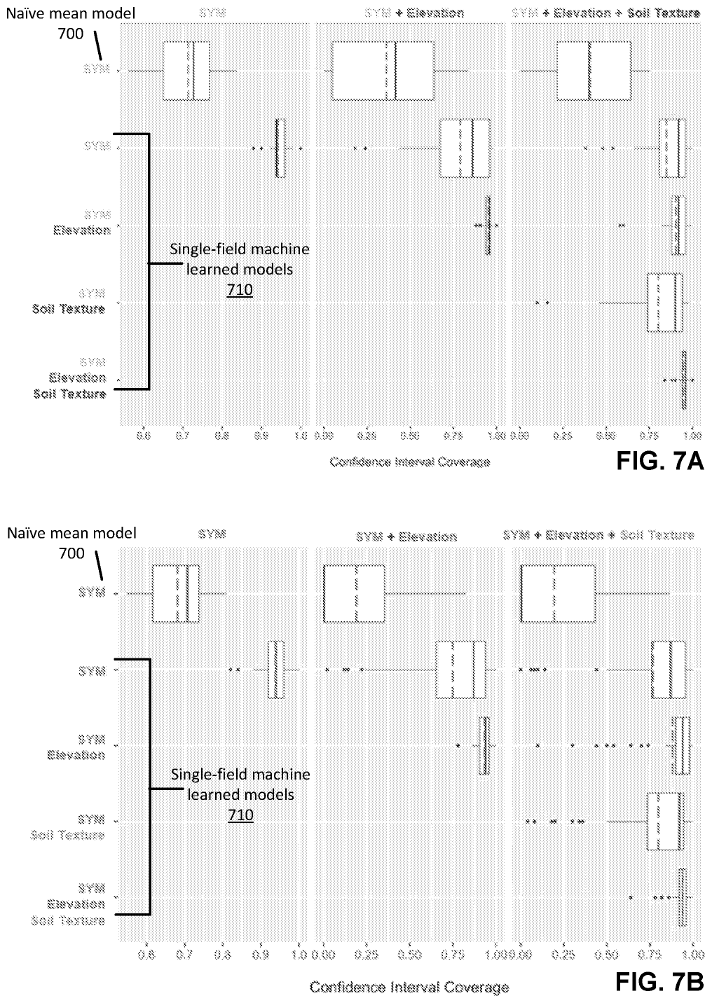

FIG. 7A illustrates intervention effect prediction performance data for multiple variants of a single-field model relative to a naïve mean model simulated based on real-world historical field outcome data for 21 winter wheat field trials, according to various embodiments. In the embodiment of FIG. 7A, −50 simulations were performed using an industry-standard naïve mean model 700 and using single-field predictive model variants 710 for each of three contexts: 1) “SYM”, referring to a predictive effect of an intervention, 2) “SYM+Elevation”, referring to a predictive effect of an intervention when considering field elevation, and 3) “SYM+Elevation+Soil Texture”, referring to a predictive effect of an intervention when considering field elevation and field soil texture.

In the embodiment of FIG. 7A, the single-field model (the “SYM” model 710) described herein significantly outperforms the industry standard naïve mean model 700 for each of the three contexts. Even when significant environmental conditions are unobserved, the single-field model is able to produce improved intervention effect estimates even under missing data settings. As used herein, “outperforms” refers to an increased confidence that a first model properly attributes a crop outcome to an intervention. The simulation further includes three additional single-field model variants 710, each featurized to include additional data layers (the first is “SYM Elevation”, which is featurized additionally based on an elevation data layer, the second is “SYM Soil Texture”, which is featurized additionally based on a soil texture data layer, and the third is “SYM Election Soil Texture”, which is featurized additionally based on an elevation data layer and a soil texture data layer). Each of these additional single-field model variants 710 further outperforms the “SYM” model 700.

FIG. 7B illustrates intervention effect prediction performance data for multiple variants of a single-field model relative to a naïve mean model simulated based on real-world historical field outcome data for 18 corn field trials, according to various embodiments. As with the embodiment of FIG. 7A, the single-field machine learned models 710 significantly outperform the naïve mean model 700 across each of the three context (“SYM”, “SYM+Elevation”, and “SYM+Elevation+Soil Texture”). Based on the distribution of confidence interval coverages, the simulated data illustrates that the spatial models outperform the mean estimate models across different fields, different circumstances, and various field configurations.

### Multi-Field Machine-Learned Models

As noted above, the machine-learned models trained on data representative of intervention effects on crop outcomes within a single field can additionally be trained on data representative of intervention effects on crop outcomes across multiple fields according to the principles described herein. In some embodiments, training the machine-learned models on multiple fields may better help the models to identify correlations between interventions and corresponding effects on crop outcomes, may better account or control for the effect characteristics of the fields or crops themselves have on crop outcomes (either in isolation or in combination with the intervention), and/or may increase the environmental spatial diversity associated with geographically distributed and distinct field locations to improve the performance of the machine-learned models.

The intervention and crop outcome data used to select predictive models on which a multi-field model is trained can be associated with any number of fields. Likewise, the fields can be located at any number of geographically or geologically distinct locations. In some embodiments, the fields are associated with a threshold diversity for one or more features are selected. For instance, fields corresponding to a representative cross-section of one or more field characteristics or properties can be selected. In some embodiments, the fields are instead or additionally associated with a threshold similarly for one or more features are selected. For instance, fields that are associated with a threshold geographic diversity within a region or country may also each be associated with a similar altitude or expected rainfall quantity. In some embodiments, the fields are associated with a same crop, planting operation or technique, farming operation, or other common characteristic.

The amount of available field data (e.g., intervention, crop outcome, and field/crop characteristics data) scales with the number of fields available for analysis. In addition, each field can include any number of field portions (e.g., 2, 5, 10, 20, 50, 100, or more), each corresponding to interventions performed on the field portion and resulting crop outcomes. In practice, evaluating predictive models for each available field portion may be computationally infeasible for generating a spatially-adjusted joint probability model. Accordingly, the farming management system 110 may preprocess the data in order reduce the quantity of data considered while preserving the utility of the data for training a machine-learned model to predict an effect that an intervention has on a crop outcome.

The farming management system 110 can perform any number of pre-processing operations on the field data associated with a plurality of fields and/or field portions. A first example pre-processing operation is a spatial aggregation operation. The spatial aggregation operation can include any suitable operation that reduces the sample size and/or noise of the field data. For instance, the field data can be rasterized using a grid size selected to satisfy a stability criteria, based on the size of the field data dataset, or based on any other suitable criteria. A second example pre-processing operation is a stratified sampling operation. In some embodiments, performing a stratified sampling operation divides the fields into related subsets and samples within the subsets in order to reduce the total field data dataset while maintaining the representativeness of the reduced dataset relative to the entire field data dataset.

After pre-processing the field data, the farming management system 110 generates a training set of data, for instance using a variant of the process of FIG. 4. In practice, the process of FIG. 4 can be modified to generate training data from multiple distinct and/or distributed fields for the training of a multi-field predictive model. In such embodiments, preprocessed historical field data is accessed, and the feature selection engine 210 selects features from the information corresponding to a set of historical fields or field portions associated with the preprocessed historical field data. As in the embodiment of FIG. 4, predictive models can be applied to the selected features, and a best performing predictive model can be selected for each of the set of historical fields or field portions. And as in the embodiment of FIG. 4, the effect prediction engine 430 can determine the effect that one or more interventions has on crop yield using the selected predictive model for each of the set of historical fields or field portions. The determined intervention effects on crop outcomes can then be used to train a multi-field machine-learned model.

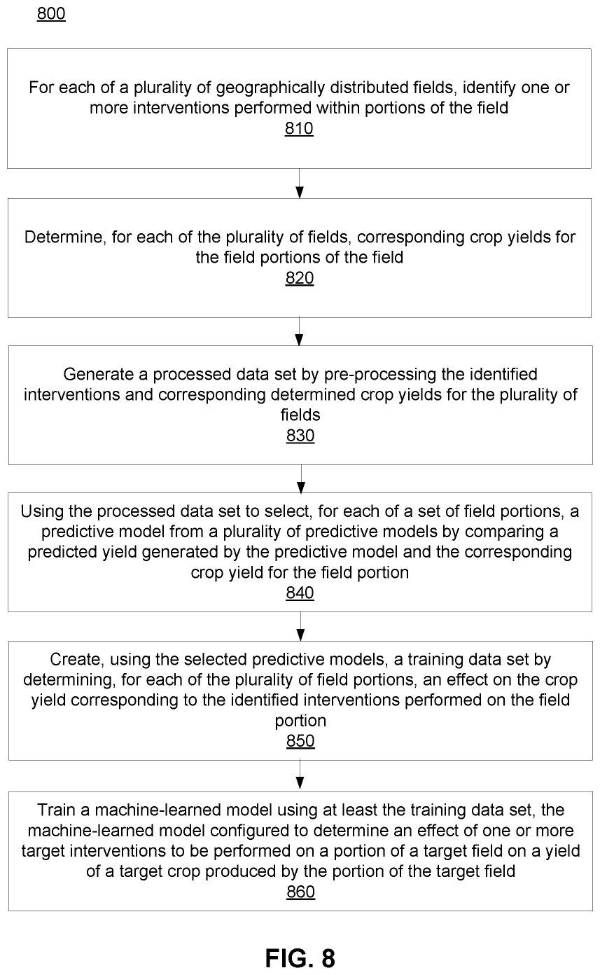

FIG. 8 is a flow chart illustrating a process 800 for training a multi-field machine-learned model for predicting effects of interventions on a target field, according to various embodiments. One or more interventions performed within a field portion are identified 810 for each of a plurality of field portions in a set of geographically distributed fields. Crop yields corresponding to the field portions are determined 820 for each of the set of fields. Data corresponding to the identified interventions and the corresponding determined crop yields is preprocessed to generate 830 a processed data set.

The processed data is used to select 840, for each of a set of field portions, a predictive model from a plurality of predictive models by comparing a predicted yield or crop outcome generated by the predictive model and the corresponding crop yield for the field portion. A training set of data is created 850 by determining, for each of the plurality of field portions, an effect on the crop yield corresponding to the identified interventions performed on the field portion. A machine-learned model is then trained 860 using the training data set. The trained machine-learned model is configured to determine an effect of one or more target interventions to be performed on a portion of a target field on a yield of a target crop produced by the portion of the target field.

In practice, a crop producer (or grower 130) can leverage predictions made by both single-field models and multi-field models to determine an expected effect of one or more interventions on a crop outcome for a target field. The crop producer can provide information representative of a target field (such as field characteristics, soil type, expected weather, etc.) and information representative of a target crop to plant or planted within the target field (such as a crop variant, a planting date, a harvest date, etc.) to the farming management system 110. The farming management system 110 can apply one or both of the single-field or multi-field models described herein to determine an effect that one or more interventions (e.g., interventions identified by the crop producer, interventions generated by the farming management system, etc.) will have on a crop outcome for the target field.

In some embodiments, a single-field model may perform better than a multi-field model, for instance in embodiments where a target field is more similar to the field used to train the single-field model than to (for example) an average field or field otherwise representative of the fields used to train a multi-field model. The inverse may also be true—a multi-field model may perform better than a single-field model when the target field is below a threshold similarity to the field used to train the single-field model, or is above a threshold similarity to an average field or field otherwise representative of the fields used to train a multi-field model.

Accordingly, a crop producer can leverage the predictive outcomes of both a single-field model and a multi-field model to determine an effect that one or more interventions may have on a target field. In some embodiments, the farming management system 110 can average (weighted or unweighted) predicted effects of one or more interventions, and can provide the average predicted effects for one or more interventions to the crop producer.

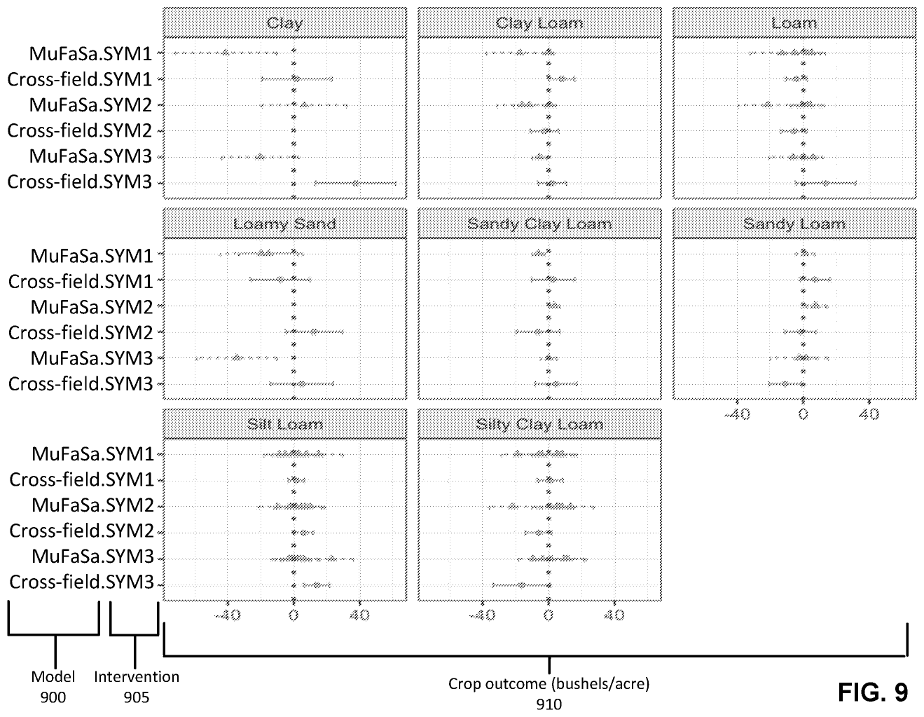

FIG. 9 illustrates intervention effect prediction performance data for multiple interventions using both single-field and multi-field prediction models simulated based on historical field outcome data, according to various embodiments. In the embodiment of FIG. 9, the models include single-field models (labeled “MuFaSa”) and multi-field models (labeled “cross-field”). The performance of the models is simulated based on real-world historical field outcome data for each of a set of interventions 905 (e.g., the intervention “SYM1”, the intervention “SYM2”, and the intervention “SYM3”).

The performance of the models is likewise simulated for each of a plurality of soil types: clay, clay loam, loam, loamy sand, sandy clay loam, sandy loam, silt loam, and silty clay loam. Crop outcomes 910 in bushels/acre are illustrated for each intervention type and each soil type. Generally (though not always) the confidence intervals for the multi-field models are narrower than the confidence intervals for the single-field models. Accordingly, providing predicted effects using both single-field and multi-field models can improve the performance of the predictions made by the farming management system 110 and can empower crop producers to make decisions informed by a range of modeled predictions.

It should be noted that the models described herein can be applied to interventions that have already been performed on a target field in order to predict the effect that the already-performed interventions will have on a crop outcome for the target field. For instance, a user can use one or both of a single-field model and a multi-field model to determine the effect that a nutrient treatment applied a week ago will have on wheat yield for a portion of a target field planted with wheat. If the predicted effect of the already-performed intervention on the crop outcome, or the crop outcome itself differs from a historical treatment effect or crop outcome (e.g., by a threshold amount from a previous year, by a threshold amount from an average or median value from multiple previous years), a notification can be automatically generated and sent to a client device of the user. Likewise, if the predicted effect of the already-performed intervention differs by a threshold amount from a previously-predicted effect of the intervention (e.g., either before or after the invention was performed), a notification can be automatically generated and sent to a user's client device.

In some embodiments, a content item can be generated by the farming management system to include interventions, field characteristics, crop characteristics, and the like to a user. For instance, a notification, an image, an interactive widget, an advertisement, or the like can be generated to identify a particular performed intervention operation, and to indicate how the particular intervention operation improved a crop outcome. The generated content can be displayed within an interface displayed by a device of a user, and can indicate to the user how the intervention or characteristic is attributable to a particular crop outcome. The generated content can additionally enable the user to provide information representative of one or more fields or field portions to the farming management system, which in response can identify one or more interventions to the user that, if performed, can improve a crop outcome for one or more of the fields or field portions.

### OTHER CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, as noted above, the described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus or system for performing the operations herein. Such an apparatus or system may be specially constructed for the required purposes, and/or it may comprise a general-purpose computing device selectively activated or reconfigured by a computer program stored in the computer. Such a computer program may be stored in a nontransitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may include information resulting from a computing process, where the information is stored on a nontransitory, computer readable storage medium and may include any embodiment of a computer program product or other data described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. A method comprising:
for each of a plurality of portions of a field, identifying one or more interventions performed on the portion of the field by receiving remote sensing data associated with the portion of the field and determining, based on the remote sensing data, interventions performed on the portion of the field;
determining, for each of the plurality of portions of the field, a corresponding crop outcome for the portion of the field;
for each portion of the field, selecting a predictive model from a plurality of predictive models based on a comparison of a predicted crop outcome generated by the predictive model and the corresponding crop outcome for the portion of the field;
creating, using the selected predictive models, a training data set by determining, for each of the plurality of portions of the field, an effect on the crop outcome corresponding to the identified interventions performed on the portion of the field; and
training a machine-learned model using at least the training data set, the machine-learned model configured to determine an effect of one or more target interventions to be performed on a portion of a target field on a crop outcome of a target crop produced by the portion of the target field.

2. The method of claim 1, wherein identifying one or more interventions performed on a portion of a field comprises receiving information describing the one or more interventions from a user associated with the field.

3. (canceled)

4. The method of claim 1, wherein the remote sensing data comprise one or more of imagery, thermal measurements, microwave measurements, radar measurements, and lidar measurements.

5. The method of claim 1, wherein selecting, for a portion of the field, a predictive model from the plurality of predict models further comprises:
selecting a first set of features corresponding to the portion of the field;
identifying a subset of the plurality of predictive models configured to receive one or more of the first set of features as inputs; and
selecting a predictive model from the identified subset of predictive models.

6. The method of claim 5, wherein selecting the predictive model from the plurality of predictive models comprises:
applying each of the subset of the plurality of predictive models to the first set of features, each of the subset of predictive models configured to output a predicted crop outcome based on the first set of features; and
selecting the predictive model from the subset of predictive models corresponding the predicted crop outcome closest to a crop outcome corresponding to the portion of the field.

7. The method of claim 5, wherein the first set of features includes one or more of: intervention products applied to the portion of the field, fertilizer applied to the portion of the field, biological product applied to the portion of the field, fungicide applied to the portion of the field, a type of tillage performed in the portion of the field, an intensity of grazing in the portion of the field, a type of cover crops plated in the portion of the field, a planting date for the portion of the field, an amount or pattern of water applied to the portion of the field, a type of crop planted in the portion of the field, a characteristic of the crop planted in the portion of the field, a seeding rate of the crop planted in the portion of the field, a planting date of the crop planted in the portion of the field, a characteristic of soil of the portion of the field, a moisture level of the soil of the portion of the field, historic weather information associated with the portion of the field, predicted weather information associated with the portion of the field, historical productivity associated with the portion of the field, and a topographical feature associated with the portion of the field.

8. (canceled)

9. (canceled)

10. The method of claim 1, wherein the machine-learned model is trained in response to selecting the predictive models and creating the training data set, without human intervention, wherein the plurality of predictive models include one or both of statistical models and machine-learned models, and wherein the machine-learned model comprises one or more of: a neural network, a decision tree, a polynomial regression model, and a Bayesian network.

11. The method of claim 1, wherein one or more of the plurality of predictive models are trained in advance of determining crop outcomes corresponding to portions of the field or in response to determining crop outcomes corresponding to portions of the field, and wherein a predictive model is selected from the plurality of predictive models automatically and without human intervention.

12. (canceled)

13. (canceled)

14. The method of claim 1, wherein the training data set is created by additionally determining, for each of the plurality of portions of the field, an effect on the crop outcome corresponding to one or more of: an intervention applied to a portion of the field, characteristics of the portion of the field, characteristics of historic or predicted weather for the portion of the field, characteristics of a crop planted within the portion of the field, and characteristics of a harvest of the crop planted within the portion of the field.

15. (canceled)

16. The method of claim 1, further comprising adding the trained machine-learned model to the plurality of predictive models.

17. The method of claim 1, further comprising:
applying the trained machine-learned model to each of a plurality of sets of target interventions;
selecting a set of the plurality of sets of target interventions corresponding to a greatest target crop outcome for the portion of the target field; and
modifying a displayed interface to include the selected set of target interventions.

18. The method of claim 17, further comprising:
receiving information identifying one or more of the selected set of target interventions performed on the portion of the target field;
determining a corresponding crop outcome of the target crop produced by the portion of the target field; and
retraining the machine-learned model based on the one or more of the selected set of target interventions and the determined crop outcome of the target crop produced by the portion of the target field.

19. A method of claim 1, wherein the crop outcome is a crop yield, a crop quality, an amount of soil organic carbon or a greenhouse gas sequestered or abated, or a crop health metric.

20. (canceled)

21. The method of claim 1, further comprising:
accessing additional data representative of one or both of additional interventions performed on a set of portions of the field and additional crop outcomes associated with the set of portions of the field;
selecting one or more additional predictive models in response to accessing the additional data;
updating the training data set using the selected additional predictive models; and
retraining the machine-learned model using the updated training set.

22. The method of claim 21, wherein the machine-learned model is retrained automatically in response to the additional data being accessed and without human intervention, wherein the additional data is generated by one or more remote sensors, and wherein the additional data comprises a vegetative index data associated with the set of portions of the field and derived from data captured by one or more remote sensors.

23. (canceled)

24. (canceled)

25. The method of claim 21, wherein the additional interventions are detected by one or more remote sensors, wherein the additional interventions comprise one or more of: a cover crop action, an irrigation event, a tillage event, a grazing event, a crop planting event, and a crop harvesting event, and wherein the additional data is a measure of soil organic carbon or greenhouse gas emissions.

26. (canceled)

27. (canceled)

28. The method of claim 1, wherein the machine-learned model is trained or retrained more than once per crop growing season.

29. The method of claim 1, further comprising:
automatically providing a notification to a user device including the determined effect on the crop outcome for the one or more target interventions to be performed on the portion of the target field.

30-44. (canceled)

45. (canceled)

46. (canceled)
